(19) United States
(12) Patent Application Publication
(10) Pub. No.: US 2006/0135139 A1
(43) Pub. Date: Jun. 22, 2006

(54) METHOD FOR CHANGING OUTPUTTING SETTINGS FOR A MOBILE UNIT BASED ON USER'S PHYSICAL STATUS

(76) Inventors: Steven D. Cheng, San Diego, CA (US); Chia-chi Sung, San Diego, CA (US)

Correspondence Address: NORTH AMERICA INTELLECTUAL PROPERTY CORPORATION, P.O. BOX 506, MERRIFIELD, VA, 22116, US

(21) Appl. No.: 10/905,133

(22) Filed: Dec. 17, 2004

(51) Int. Cl. H04M 3/00

(52) U.S. Cl. 455/418; 455/456.6

(57) ABSTRACT

A method for changing outputting settings for a mobile unit. The mobile unit has a user profile of a user, and the user profile contains a first data and a second data corresponding to first settings and second settings. The method includes monitoring the user's physical status to gather a third data, comparing the third data to the first data and the second data for selecting the outputting settings from the first settings and the second settings, and adjusting at least one output device of the mobile unit by the outputting settings.

### BACKGROUND OF INVENTION

1. Field of the Invention

The present invention relates to alert settings of a mobile station, and more specifically, to a method for adjusting alert settings of the mobile station according to the user's physical status for improving the mood of the user.

2. Description of the Prior Art

Modern mobile stations such as mobile phones can be customized in a variety of ways. For instance, users can program the mobile station's audio settings, such as ring-tones and message alerts. In addition, font-light and other visual settings can also be customized. Both the ring-tones and font-lights have become two major user interface features in the modern wireless device design, and they can generate the different audio and visual effects to attract the user's attention.

Unfortunately, the existing way to program the ring-tone and font-light is done in a static way. That is, the ring-tone and font-light will not be changed unless the user re-programs them. Since different ring-tones and font-lights give people different feelings, sometimes it is inappropriate to use the same ring-tone and font-light settings to alert the user when the user is in a good mood versus when the user is in a bad mood. If the wrong settings are used when the user is in a bad mood, the situation may become worse.

### SUMMARY OF INVENTION

It is therefore an objective of the claimed invention to provide a method for changing outputting settings of a mobile unit according to a user's physical status in order to solve the above-mentioned problems.

According to the claimed invention, a method for changing outputting settings for a mobile unit is proposed. The mobile unit has a user profile of a user, and the user profile contains a first data and a second data corresponding to first settings and second settings. The method includes monitoring the user's physical status to gather a third data, comparing the third data to the first data and the second data for selecting the outputting settings from the first settings and the second settings, and adjusting at least one output device of the mobile unit by the outputting settings.

It is another objective of the claimed invention to provide a mobile unit that can improve a user's mood. The mobile unit includes a memory for storing a user's profile containing a first data and a second data corresponding to first settings and second settings, an input device for gathering a third data corresponding to the user's physical status, and a controller for selecting outputting settings, selecting the first settings as the outputting settings if the third data is substantially equal to the first data, and selecting the second settings as the outputting settings if the third data is substantially equal to the second data. An output device presents an output signal of the mobile unit, and the output device is adjusted by the outputting settings.

It is an advantage of the claimed invention that the mobile unit can detect the user's physical status and adjust the outputting settings in order to improve the mood of the user. Moreover, the outputting settings are dynamically and automatically updated without the need for the user to actively change the settings.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a mobile station according to the present invention.

FIG. 2 is a functional block diagram of a mobile station according to a first embodiment of the present invention.

FIG. 3 is a functional block diagram of a mobile station according to a second embodiment of the present invention.

FIG. 4 is a functional block diagram of a mobile station according to a third embodiment of the present invention.

FIG. 5 is a diagram showing how the mobile station captures images of the user's face using a camera.

FIG. 6 is a functional block diagram of a mobile station according to a fourth embodiment of the present invention.

FIG. 7 is a functional block diagram of a mobile station according to a fifth embodiment of the present invention.

### DETAILED DESCRIPTION

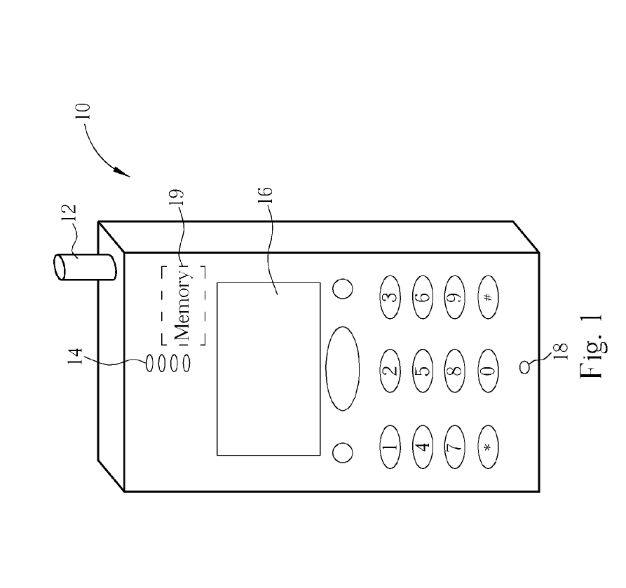

Please refer to FIG. 1. FIG. 1 is a diagram of a mobile station 10 according to the present invention. The mobile station 10 comprises an antenna 12, a speaker 14, a display 16, and a microphone 18. The mobile station 10 also contains a memory 19 for storing data and software programs utilized by the mobile station 10.

As will be explained below, the present invention measures the physical status of a user of the mobile station 10, and adjusts alert settings of the mobile station 10 in such a way as to improve the mood of the user. Some of the alert settings that may be adjusted using the present invention method are the ring-tones, incoming message alerts, font-lights, display panel settings, and voice-synthesizer settings of the mobile station 10.

The present invention method is implemented in five basic steps.

Step 1: The mobile station 10 will utilize the default alert settings provided by the manufacturer of the mobile station 10. The users can modify these default settings at any time.

Step 2: The mobile station 10 will collect data from the user through one or more input devices on the mobile station 10. Each of these input devices will be explained fully in the different embodiments presented below.

Step 3: The collected data is compared with data stored in a user profile. The user profile, which is stored in the memory 19, is gradually built over time to slowly provide an accurate depiction of a user's mood with respect to the measured data. The user profile contains at least a first data and a second data. The first and second data respectively correspond to first and second alert settings. If the collected data is within a range specified by the first data, the alert settings of the mobile station 10 will be configured using the first settings of the user profile. On the other hand, the second settings will be used if the collected data is within the range specified by the second data.

Step 4: The alert settings of the mobile station 10 are configured according to the determination made in step 4.

Step 5: When outputting alerting events, the mobile station 10 uses the newly configured alert settings to alert users to the events.

Most mobile stations on the market today only include steps 1 and 5 for changing alert settings. However, the present invention uses all of the steps 1 through 5 for detecting the user's mood based on physical characteristics and for changing the alert settings accordingly.

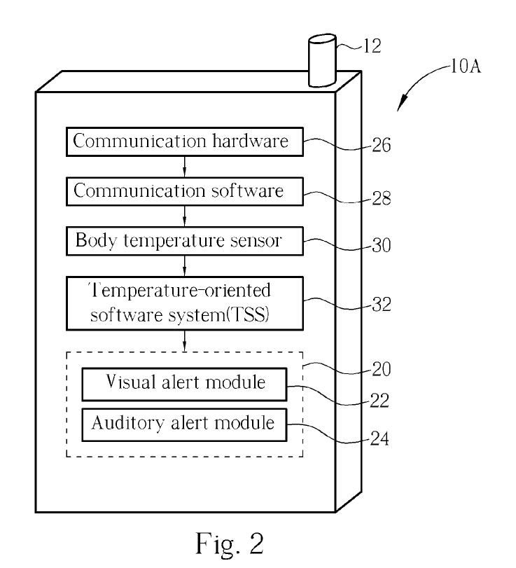

Please refer to FIG. 2. FIG. 2 is a functional block diagram of a mobile station 10A according to a first embodiment of the present invention. The mobile station 10A contains communication software 28 stored in the memory 19 for controlling operation of communication hardware 26.

The mobile station 10A of the first embodiment contains a body temperature sensor 30 for measuring the body temperature of the user of the mobile station 10A. The temperature measured with the body temperature sensor 30 is then sent to a temperature-oriented software system (TSS) 32. The TSS 32 compares the measured temperature with temperature data contained in the user profile stored in memory 19 and retrieves the alert settings that will be used to update the output devices of the mobile station 10A. The retrieved alert settings are then sent to an output device controller 20, which contains a visual alert module 22 and an auditory alert module 24. The visual alert module 22 adjusts light illumination characteristics of the mobile station 10A and also adjusts graphics, fonts, and words used on the display 16 of the mobile station 10A. The auditory alert module 24 controls the ring-tones, synthesized voices, and other sounds output by the speaker 14 of the mobile station 10A.

The body temperature sensor 30 can be formed anywhere on the housing of the mobile station 10A. When the user is talking on the mobile station 10A or pressing the buttons or keys of the mobile station 10A, the body temperature sensor 30 will measure the user's temperature. The TSS 32 may use either an instantaneous temperature or a run-time average temperature for comparing with the temperature data of the user profile. Once the TSS 32 has matched the current temperature information with one of the conditions stored in the user profile, a corresponding handler will be initiated in the output device controller 20. The handler will normally only adjust the visual and auditory alert settings using the visual alert module 22 and the auditory alert module 24. The body temperature sensor 30 can also detect if the user is sick or not. For example if the user's temperature is over 37.8 degrees Celsius (100 Fahrenheit), the TSS 32 can inform the user of this fact. If the user's temperature remains high for a predetermined period of time and if the user does not respond to confirmation prompts of the mobile station 10A, the handler can even instruct the mobile station 10A to notify a close friend or relative of the user or to notify a doctor or hospital.

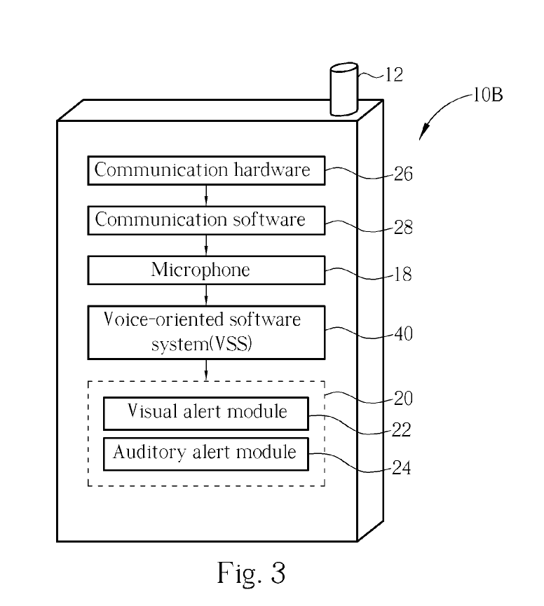

Please refer to FIG. 3. FIG. 3 is a functional block diagram of a mobile station 10B according to a second embodiment of the present invention. The mobile station 10B utilizes the microphone 18 for receiving a voice signal of the user. People typically produce small changes in their voice when they are in different moods. The present invention uses a voice-oriented software system (VSS) 40 to analyze the voice signals and detect these changes in the voice. The VSS 40 analyzes voice characteristics such as voice speed, tone of voice, volume level, or the presence of predetermined words in the voice signal. Each of these characteristics are indicative of the mood of the user.

In order to save power, this feature will normally only be used when the user is making a phone call with the mobile station 10B. If power consumption is not an issue, then the voice detection feature can be activated continuously. If the user's voice indicates that the user is laughing, crying, yelling, or in any other kind of mood, the VSS 40 will execute the appropriate handlers in the visual alert module 22 and the auditory alert module 24.

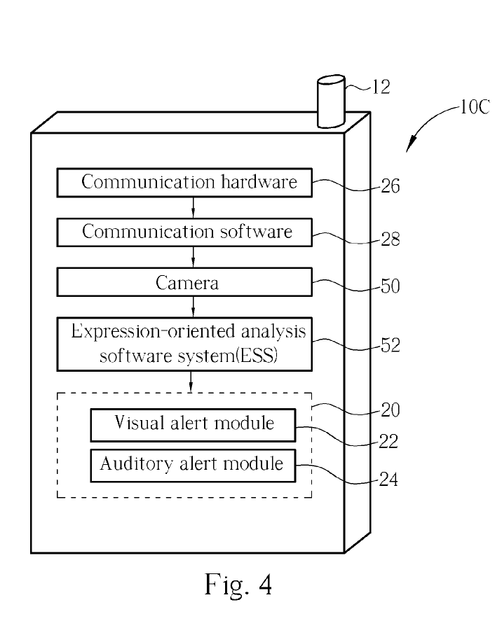

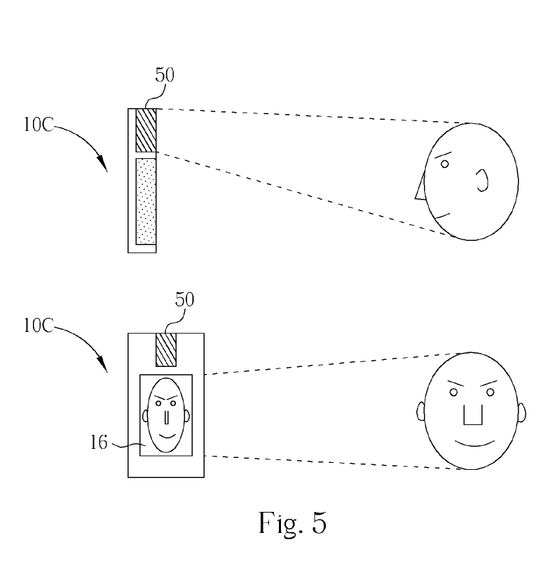

Please refer to FIGS. 4 and 5. FIG. 4 is a functional block diagram of a mobile station 10C according to a third embodiment of the present invention. The mobile station 10C utilizes a camera 50 for capturing images of the mobile station 10C user. The images are then sent to an expression-oriented analysis software system (ESS) 52. The ESS 52 analyzes the images, compares the images of the user with data in the user profile, and sends corresponding commands to the visual alert module 22 and the auditory alert module 24. FIG. 5 is a diagram showing how the mobile station 10C captures images of the user's face using the camera 50. The face is perhaps the best indicator of a person's mood. By comparing facial images with image data stored in the user profile, a very accurate analysis of the user's mood can be performed. The camera 50 can be activated whenever the user is having a conversation or when the user is using other features of the mobile station 10C, such as playing games on the mobile station 10C.

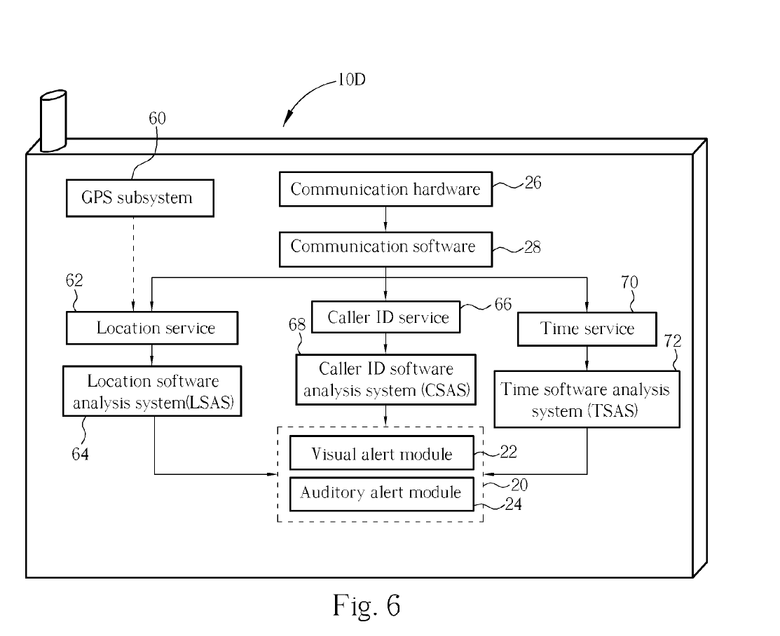

Please refer to FIG. 6. FIG. 6 is a functional block diagram of a mobile station 10D according to a fourth embodiment of the present invention. The fourth embodiment mobile station 10D can make use of location information, caller ID information, and time information when deciding how to adjust the alert settings of the mobile station 10D.

The user's location may greatly affect his mood. For instance, a user may feel more carefree at home or in the park than at the office. The user may also feel more stressed when traveling through an area with a high crime rate or when going to see their boss, going to court, or visiting the police station.

Wireless networks usually have many base stations each covering a small geographical area. The mobile station 10D can get rough location information by using the identification of the nearest base stations. In addition, the mobile station 10D may have location service capabilities like a Global Positioning System (GPS) subsystem 60 (drawn in with dotted lines in FIG. 6 to indicate that the GPS subsystem 60 is optional) which provide much more accurate location information for the mobile station 10D.

Most people tend to perform similar activities in the same place, and they tend to spend most of the time in a small fixed set of places, like home and the office. As a result, their emotional states are affected by their whereabouts. The mobile station 10D will decide if the current location falls within any specific place, and change its alerting method accordingly. The mobile station 10D will update it's location whenever it detects a new base station, whenever the GPS subsystem 60 detects a change of distance greater than a threshold level, or at a periodic interval.

The mobile station 10D has a location service circuit 62 for determining the location of the mobile station 10D. As mentioned above, the location can be determined through the base stations or through the optional GPS subsystem 60. The location service circuit 62 then sends the location information to a location software analysis system (LSAS) 64 which compares the current location with the location data stored in the user profile. The LSAS 64 will then control the visual alert module 22 and the auditory alert module 24 to change the alert settings of the mobile station 10D.

Just as with the location, the user's mood and stress level can also be positively or negatively affected depending on whom the user is talking to. When the user of the mobile station 10D receives a call from someone, a caller ID service circuit 66 will provide caller ID information. The caller ID service circuit 66 will then send the caller ID information to a caller ID software analysis system (CSAS) 68. The CSAS 68 analyzes the phone number to see if the number is on either an approved list or a non-approved list of callers. If so, the CSAS 68 will instruct the visual alert module 22 and the auditory alert module 24 to change the alert settings accordingly. In addition, if the CSAS 68 determines that the caller is on the approved caller list, the mobile station 10D may send a message to the caller's phone to inform the caller of the user's mood.

The current time will also influence the user's mood. The time of day, the day of the week, and the day of the month or year all have significance to most people, and will therefore affect their mood. Birthdays, holidays, paydays, Mondays, and Fridays all can affect people's moods. The mobile station 10D has a time service circuit 70 for indicating the current time. The time service circuit 70 can receive the time from the clock of the mobile station 10D or from the network. As long as the mobile station 10D is able to receive the network's signal for several minutes, it will have the accurate time and date information of the local region. The time service circuit 70 provides the current time information to a time software analysis system (TSAS) 72. The TSAS 72 compares the current time with time data stored in the user profile, and instructs the visual alert module 22 and the auditory alert module 24 to change the alert settings accordingly. In order to conserve power, the TSAS 72 and time service circuit 70 will periodically analyze the current time and will enter a sleep mode or standby mode when not in operation.

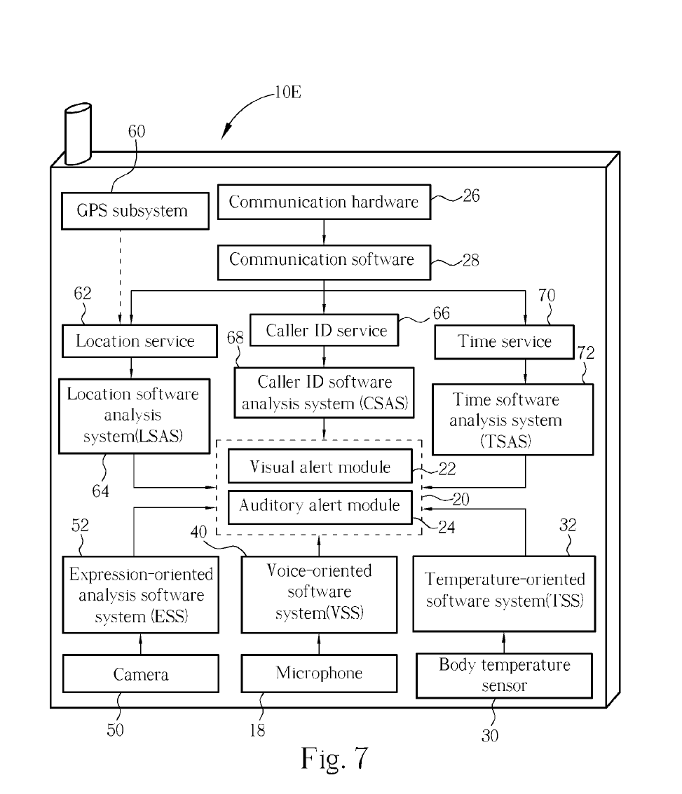

FIG. 7 is a functional block diagram of a mobile station 10E according to a fifth embodiment of the present invention. The mobile station 10E is a combination of the previous embodiments of the mobile station 10. That is, the alert settings can be changed according to data from the body temperature sensor 30, the microphone 18, the camera 50, the location service circuit 62, the caller ID service circuit 66, and the time service circuit 70. Any one or a combination of these devices can be used to provide information indicating the user's mood. The visual alert module 22 and the auditory alert module 24 will then adjust the alert settings in such a way as to improve the mood of the user.

In contrast to the prior art, the mobile station of the present invention detects the user's physical status and adjusts the alert settings in order to improve the mood of the user. The user no longer has to manually update the alert settings to suit his current mood. Instead, the outputting settings are dynamically and automatically updated without the need for the user to actively change the settings.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for changing outputting settings for a mobile unit, the mobile unit having a user profile of a user, the user profile containing a first data and a second data corresponding to first settings and second settings, the method comprising:
monitoring the user's physical status to gather a third data;
comparing the third data to the first data and the second data for selecting the outputting settings from the first settings and the second settings; and
adjusting at least one output device of the mobile unit by the outputting settings.

2. The method of claim 1 wherein the output device is a speaker, and adjusting the outputting settings of the speaker comprises modifying a ring-tone of the mobile unit.

3. The method of claim 1 wherein the output device is at least one light of the mobile unit, and adjusting the outputting settings of the light comprises modifying illumination characteristics of the light.

4. The method of claim 1 wherein the output device is a display panel of the mobile unit, and adjusting the outputting settings of the display panel comprises modifying graphics, fonts, or words that are presented on the display panel.

5. The method of claim 1, wherein the mobile unit further comprises a microphone, the method further comprising:
receiving a voice signal of the user by the microphone during a predetermined period;
detecting a characteristic of the voice signal;
saving the characteristic as the third data; and
selecting the first settings if the third data is substantially equal to the first data and selecting the second settings if the third data is substantially equal to the second data.

6. The method of claim 5 wherein the characteristic is a voice speed, a tone of the voice signal, a volume level of the voice signal, or predetermined words in the voice signal.

7. The method of claim 1 wherein the mobile unit further comprises a camera, the method further comprising:
saving a first image of the user as the first data and a second image of the user as the second data;
capturing a current image of the user by the camera;
saving the current image as the third data; and
selecting the first settings if the third data is substantially equal to the first data and selecting the second settings if the third data is substantially equal to the second data.

8. The method of claim 1 wherein the mobile unit further comprises a temperature sensor, the method further comprising:
detecting the user's current body temperature as the third data by the temperature sensor;
selecting the first settings if the third data is substantially equal to the first data and selecting the second settings if the third data is substantially equal to the second data.

9. The method of claim 8 further comprising contacting emergency services when the user's body temperature exceeds a predetermined threshold level.

10. The method of claim 1, further comprising:
receiving an incoming call from a remote mobile unit and detecting the phone number of the incoming call;
comparing the phone number to a list of approved callers; and
sending a current status to the remote mobile unit with the mobile unit if the phone number is in the list of approved callers, the current status corresponding to the outputting settings.

11. A mobile unit, comprising:
a memory for storing a user's profile containing a first data and a second data corresponding to first settings and second settings;
an input device for gathering a third data corresponding to the user's physical status;
a controller for selecting outputting settings, selecting the first settings as the outputting settings if the third data is substantially equal to the first data, and selecting the second settings as the outputting settings if the third data is substantially equal to the second data; and
an output device for presenting an output signal of the mobile unit, the output device adjusted by the outputting settings.

12. The mobile unit of claim 11 wherein the output device is a speaker used to output ring-tones or synthesized voices.

13. The mobile unit of claim 11 wherein the output device is a light with adjustable illumination characteristics.

14. The mobile unit of claim 11 wherein the output device is a display panel with adjustable graphics, fonts, or words that are presented on the display panel.

15. The mobile unit of claim 11 wherein the input device is a microphone used to receive a voice signal of the user by the microphone during a predetermined period.

16. The mobile unit of claim 15, wherein the controller detects a characteristic of the voice signal as the third data, the characteristic being a voice speed, a tone of the voice signal, a volume level of the voice signal, or predetermined words in the voice signal.

17. The mobile unit of claim 11 wherein the input device is a camera used to capture images of the user's facial expression.

18. The mobile unit of claim 11 wherein the input device is a temperature sensor used to detect the user's body temperature.

19. The mobile unit of claim 11 wherein the input device is a clock for detecting the current time and date.

20. The mobile unit of claim 11 wherein the input device is a location detecting circuit for detecting the current geographical location of the mobile unit.
